(19) United States
(12) Patent Application Publication
(10) Pub. No.: US 2009/0177767 A1
(43) Pub. Date: Jul. 9, 2009

(54) Local Web Server Based Controller

(75) Inventor: Benjamin N. Lease, Knoxville, TN (US)

Correspondence Address: REINHART BOERNER VAN DEUREN P.C., 2215 PERRYGREEN WAY, ROCKFORD, IL, 61107, US

(73) Assignee: Robertshaw Controls Company, Richmond, VA (US)

(21) Appl. No.: 11/970,354

(22) Filed: Jan. 7, 2008

(51) Int. Cl. G06F 15/16

(52) U.S. Cl. 709/224

(57) ABSTRACT

A system for monitoring parameters related to a product in a storage tank is provided. The system includes a monitor operably coupled to the storage tank, an internet protocol (IP) enabled electronic device, and an internet protocol enabled controller. The controller is in communication with the monitor and the electronic device. The controller and the electronic device communicate through an internet regarding information observed by the monitor.

### FIELD OF THE INVENTION

This invention generally relates to tank monitoring and, in particular, to tank monitoring using an Internet-enabled controller.

### BACKGROUND OF THE INVENTION

A tank or similar vessel is often employed at a factory, construction site, warehouse, rural homestead and the like, to receive, store, and distribute a product. The products include, for example, gasoline, liquid propane, fertilizer, chemicals, fuels, and the like. Often, several of the tanks are found situated adjacent to each other in a single location.

To observe and/or measure the various characteristics and parameters of the product held inside, each of the tanks is normally outfitted with a monitor. The monitors are equipped to transmit collected product data, using a robust wireless link or other communication system, to a controller.

The controller manages the flow of information from each of the monitors and relays that information to a remotely located data center. The controller and the data center exchange information through a phone line, wireless cellular or satellite network, or some other communication system. In many cases, the controller reports to the data center according to a predetermined schedule or previously defined set of alarm conditions. At the data center, the product information is organized and warehoused.

The data center is connected to the Internet and generates a web interface customized to display the product information collected by the monitors. Using an Internet-enabled and connected electronic device (e.g., thin client, computer, personal digital assistant (PDA), Blackberry, pager, cell phone, etc.), the owner of the product (or other authorized party) is able to access the web interface and review the product information stored in the data center. Therefore, in today's Internet connected world, the product information is readily available.

Unfortunately, even though the above-noted system is exemplary for monitoring tanks, the system generally requires transmitting each packet of data through a relatively expensive communication system more than once. In the above tank monitoring system, the first transmission relays packets of data from the monitors to the controller over a wired, wireless radio frequency (RF) link. The second transmission moves the packet of data from the controller to the data center using a long distance phone network (or through a cellular or global satellite network). This second transmission requires paying for a long distance phone call or, in some cases, a cellular or global satellite network transmission. This transmission adds considerably to expenses flowing from the use of the tank monitoring system.

The expense associated with the second transmission is magnified if the transmission of data packets occurs frequently (e.g., once an hour or even more frequently). If the transmissions are reduced to a less frequent rate (e.g., once a day) in an attempt to mitigate costs, the product information stored in the data center and available for viewing by the customer is delayed and reveals only limited information about recent product parameters. As a result, this solution is not very attractive.

Therefore, it would be desirable to have a tank monitoring system that eliminates the use of one of the relatively expensive communication systems yet still permits an exchange of product information on a frequent enough basis to be valuable to the product owner. The invention provides such a system. These and other advantages of the invention, as well as additional inventive features, will be apparent from the description of the invention provided herein.

### BRIEF SUMMARY OF THE INVENTION

An embodiment of the present invention employs an internet protocol (IP) enabled controller within a tank monitoring system. The IP-enabled controller is able to communicate directly with an internet protocol enabled electronic device over a wide area network, e.g., the Internet. To facilitate this communication, the IP-enabled controller is able to host its own web page. As such, product owners are able to access and view the product information by “logging in” to the web page.

Because the IP-enabled controller is able to send packets of data through an internet as opposed to a cellular or satellite communication system, the cost of using the tank monitoring system is greatly reduced. Only one wired or RF transmission, which occurs between the monitors and the IP-enabled controller, is needed. The second transmission, which occurs between the IP-enabled controller and electronic device, is cost-effectively routed through the internet.

In one embodiment, the IP-enabled controller is able to initiate an instant messaging session with an electronic device or the data center. Because the IP enabled controller is responsible for initiating the messaging session, the communication is not blocked or hampered by network address translation (NAT) firewalls. Once the session has been initiated, product owners are able to access and view the product information by sending and/or receiving instant messages.

In addition, the IP-enabled controller is able to queue messages for sleeping nodes (i.e., monitors) and communicate after the node awakes. If the wireless monitors are each equipped with a transceiver, the product owner is able to push instructions or data back to the various monitors.

In one aspect, the invention provides a system for monitoring parameters related to a product in a storage tank. The system includes a monitor operably coupled to the storage tank, an internet protocol (IP) enabled electronic device, and an internet protocol enabled controller in communication with the monitor and the electronic device. The controller and the electronic device communicate through the Internet regarding information observed by the monitor.

In another aspect, the invention provides a system for monitoring parameters related to a product in a storage tank. The system includes a monitor operably coupled to the storage tank, an internet protocol (IP) enabled electronic device, and an internet protocol enabled controller in communication with the monitor and the electronic device. The controller and the electronic device exchange information regarding the product through the Internet using an internet protocol.

In yet another aspect, the invention provides a method of reducing transmission costs in a system employed to monitor a product in a storage tank. The method includes transmitting measured parameters of the product through a first communication network and transmitting the measured parameters of the product through a second communication network using a network layer protocol.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic view of an exemplary embodiment of a tank monitoring system including a local web server based controller in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

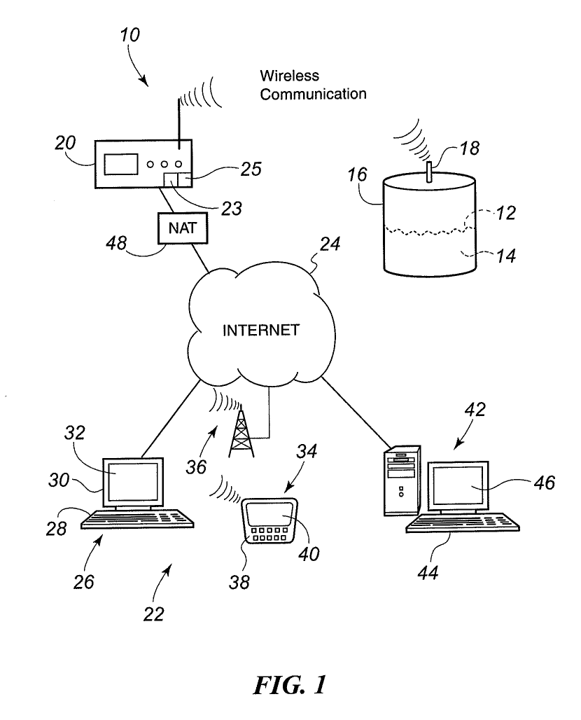

Referring to FIG. 1, a system 10 capable of monitoring a level 12 of product 14 in a tank 16 is illustrated. As will be more fully explained below, the system 10 of the present invention advantageously provides a method of substantially reducing the overall expense of using the system by reducing the cost associated with transmitting information related to the product 14 in the tank 16. The system 10 generally includes a monitor 18, a controller 20, and an electronic device 22.

As in a typical tank level monitoring system, such as the Centeron® tank level monitoring system commercially available from Robertshaw Industrial Products of Maryville, Tenn., the monitor 18 is operatively coupled to the tank 16 and designed to monitor the level 12 or another parameter of the product 14 in the tank. The monitor 18 can be one of a variety of monitors such as, for example, a gauge monitor, a radar monitor, an ultrasonic monitor, a pressure monitor, a float monitor, a capacitance monitor, and the like.

In addition to having the ability to observe the product 14 in the tank 16, the monitor 18 is able to transmit information regarding the monitor itself and/or the product to the controller 20. Such information includes, but is not limited to, the level of the product 14 in the tank 16, the temperature of the product, monitor calibration information, calculations related to product level, flow, volume, and the like, set points for both fixed and rate of rise or fall, transmission rates, measurement rates, scheduling and other critical information, and the like. In one embodiment, the monitor 18 is equipped with a transceiver. Therefore, the monitor 18 is also able to receive the above-noted information.

Communications with and from the monitor 18 occur through a wired connection or through wireless communication as shown in FIG. 1. In the illustrated embodiment, wireless communication between the monitor 18 and the controller 20 is performed through radio frequency (RF) communication, cellular transmission, or a combination of these types of communication methods depending, for example, on the distance between the monitor 18 and the controller 20.

Depending on the communication channel utilized by the particular monitor 18 and the cost/availability of data transfer over that channel, the monitor 18 may be required to store data and information regarding the product and perform logic operations between information transmission sessions. In such an embodiment, the monitor 18 is provided with, for example, a memory, a processing unit, and/or other components such that the monitor is considered to be a “smart” device. One such monitor is a digital cellular monitor commercially available from Robertshaw Industrial Products of Maryville, Tenn., which sends out only periodic cellular transmissions. The cellular transmissions may include information regarding many readings, operation of the tank, and the like, based on the cost of cellular communications.

Because the product 14 in the tank 16 is typically a bulk commodity or material such as gasoline, propane, fertilizer, chemical, fuel, waste material, and the like, the monitor 18 is preferably configured to observe and/or measure parameters involving and related to such substances or simply a level 12 thereof. Additionally, the monitor 18 is able to measure and/or gauge the level 12 of the product 14 whether the level is constant or in flux since the tank 16 is typically called upon to store, temporarily hold, disperse, and deliver the product as needed.

Still referring to FIG. 1, the controller 20 generally manages the flow of information from the monitor 18 to the electronic device 22. In that regard, the controller 20 acts an intermediary capable of receiving information from the monitor 18 and then relaying that information to the electronic device 22. In similar fashion, the controller 20 is also able to receive information from the electronic device 22 and then relay that information to the monitor 18. In other words, and as will be more fully explained below, the controller 20 takes part in a two-way exchange of information related to the product 14, the tank 16, the monitor 18, and the like between the monitor and the electronic device 22.

The controller 20 is operably coupled to the Internet 24 or other switched packet internetwork, through one of a host of well known methods. For example, the controller 20 is coupled to the internet 24 via a digital subscriber line (DSL), a cable modem, a TI connection, a modem and a dial up connection through a phone network, through a wireless connection and a wireless router, and the like.

The controller 20 is also internet protocol (IP) enabled. Therefore, the controller 20 is able to communicate with the electronic device 22 over and/or through an internet 24 using, for example, the internet protocol suite. The internet protocol suite is the set of communications protocols that implement the protocol stack on which the internet 24 (and most commercial networks) operate. In some cases, the internet protocol suite is referred to as the TCP/IP suite after two of the important and earliest defined protocols included therein, namely the Transmission Control Protocol (TCP) and the Internet Protocol (IP). In one embodiment, the controller 20 is equipped to communicate with the electronic device 22 using the Open System Interconnection Reference Model (OSI Model).

When IP-enabled, the controller 20 is able to “speak the language” of the internet 24. Because the controller 20 is IP-enabled and able to employ the internet protocol suite of protocols, the controller communicates with the electronic device 22 at a fraction of the cost of communicating through a long distance phone network, a cellular network, and/or a satellite network. The exchange of information between the controller 20 and the electronic device 22 has relatively little cost and, therefore, reduces the overall cost of using the system 10 to monitor the product 14 in the tank 16.

In addition, the controller 20 is configured to host a local web page on an internal or built in web server 25. In one embodiment, the web page associated with the controller 20 is hosted on the world wide web service operating on the internet 24. As will be more fully explained below, the user of the system 10 is able to access the web page through the internet 24 using a web browser incorporated into the electronic device 22. In one embodiment, the web page includes numerous parameters observed and/or measured by the monitor 18 relating to the product 14, diagnostic information regarding the operation of the monitor itself, information sensed regarding the tank 16, and the like. The information is, in one embodiment, neatly and efficiently packaged in a user friendly user interface (or graphic user interface) on the web page and presented to the user of the system 10.

In one embodiment, the user is able to update and/or modify instructions governing the operation of the monitor 18 by using the web page and/or the user interface displayed thereon. As noted above, to facilitate the manipulation of instructions in this regard, the monitor 18 is equipped with a transceiver to push the data back to the monitor. In other words, the transceiver-equipped monitor 18 is able to both send and receive information to and from the controller 20 in one embodiment.

Much like the monitor 18, in one embodiment the controller 20 is equipped with a memory, a processing unit, and/or other components (collectively represented by reference number 23) such that the controller is considered to be a “smart” device. In such an embodiment, the controller 20 is permitted to store a host of information received from the monitor 18 and/or the electronic device 22. As one benefit of such a configuration, the controller 20 is able to transmit a group or collection of data as opposed to individual parcels or packets of information. By transmitting sets of data instead of single pieces, costs are kept down and efficient communication is promoted. This also permits the controller 20 to queue and transmit information when most practical to do so such as, for example, during off-peak hours and less costly transmission times. Further, the controller 20 is able to activate (i.e., wake up) a deactivated (i.e., sleeping) monitor 18 (a.k.a., a node) or wait to send information to the monitor until monitor wakes up on its own.

In order to access and view the web page generated by the controller 20, the user employs one of a variety of different electronic devices 22. The electronic device 22 is operably coupled to the internet 24, in a similar manner as noted above, and includes a web browser. Any one of a variety of different web browsers is suitably employed such as, for example, Internet Explorer commercially available from the Microsoft Corporation of Redmond, Wash., Netscape commercially available from Time Warner of New York, N.Y., Mozilla Firefox commercially available from Mozilla Corporation of Mountain View, Calif., and the like. Because the electronic device 22 is internet 24 connected and includes the web browser, the electronic device is able to quickly and easily display web pages which reside on the controller 20 and/or found on websites of the world wide web service (and elsewhere). In other words, the electronic device 22 is able to communicate over and through the internet 24 to access the web page.

The electronic device 22, which receives and sends information back and forth through the controller 20 to the monitor 18, is operably coupled to the internet 24. As before, the electronic device 22 is connected to the internet according to one of a variety of well known methods.

In one embodiment, the electronic device 22 is a thin client 26. The thin client 26 includes, among other things, a keyboard 28 and a monitor 30 having a display 32. The keyboard 28 permits the user to input instructions and/or data for transmission to the controller 20 and/or monitor 18. Because the display 32 exhibits the web page generated by the controller 20 for viewing by the user, the user is able to review one or more parameters relating to the monitor 18, the storage tank 16, and/or the product 14 as well as related instructions for these devices.

In another embodiment, the electronic device 22 is a remote notification device 34. The remote notification device 34 is, for example, a personal digital assistant (PDA), a pager, a handheld device, a cellular phone, a Blackberry device, and the like. The device 34 is adapted to communicate with other electronic devices (e.g., receive and send information, synchronize with those devices, etc.). Since the device 34 is not tethered to any other piece of equipment and communicates wirelessly with, for example, a satellite or tower 36 operably coupled to the internet 24, the device is often remotely located relative to the controller 20, the monitor 18, and/or the tank 16. Like the thin client 26, the remote notification device 34 includes a keyboard 38 or other input device for data entry and a display 40 for exhibiting, among other things, the web page generated by the controller 20.

In yet another embodiment, the electronic device 22 is a data center 42. The data center 42 includes a computer, a host of network computers, a server, or a like logic device. The data center 42 may be a centralized facility which monitors and reports on numerous tank installations. The data center 42 is typically owned, operated, and maintained by either the owner of the product 14 or the manufacturer of the system 10. The data center 42 is capable of generating a web page which is accessible through the thin client 26 via the internet 24. Unlike the thin client 26, the data center 20 is well suited to make comparisons, store statistics, relay data, display information and/or perform logic calculations relating to the product 14 stored in the tank 16 and relaying that information to users.

Like the thin client 26 and the remote notification device 34, the data center includes a keyboard 44 or other input device for data entry and a display 46 for exhibiting, among other things, the web page generated by the controller 20 or the world wide web service. In the illustrated embodiment, the data center 42 is coupled to the internet 24.

In one embodiment, the controller 20 is equipped to initiate an instant messaging session with the data center 42. The instant messaging session permits a user to manipulate instructions governing operation of the controller 20 and/or the monitor 18 by sending and receiving instant messages. Because the instant messaging session is initiated by the controller 20, messages are able to pass through a network address translator (NAT) 48 and/or a firewall, router, or similar device. In this embodiment, messaging takes places both ways between the controller 20 and the data center 42. As a result, a host of information is exchanged between the electronic device 22 and the monitor 18 by way of the internet 24 and the controller 20. In one embodiment, the messages pass through the controller 20 without any or any significant manipulation. In this circumstance, the controller 20 simply acts an open, bi-directional gateway.

In computer networking, the process of network address translation, which is also known as network masquerading or IP-masquerading, involves re-writing the source and/or destination addresses of IP packets as they pass through a router or firewall. Many systems using NAT do so in order to enable multiple hosts on a private network to access the internet 24 using a single public IP address.

In operation, the monitor 18 takes a reading or measures a parameter, such as level 12, of the product 14 held in the storage tank 16. Either immediately or according to a predetermined schedule, the monitor 18 then transmits product information to the controller 20 through some form of wireless communication. Once the information is received, the controller 20 stores the information and updates the web page hosted by the controller accordingly. Therefore, the information held by the controller is up to date.

At any time thereafter, the user of the system 10 employs one of the electronic devices to “log on” the web page generated by the controller 20. After logging on, the user is presented with the web page which includes the current information. If the monitor takes and sends another reading to the controller 20, the web page is again updated to reflect this new information and quickly communicated, through the internet 24, to the user. Because the user is able to access the information held in the controller through the internet 24, the second communication noted above, which is conventionally through a relatively expensive long distance, cellular, or satellite network, is performed relatively economically.

If the user desires to instruct the controller 20 and/or monitor 18 to operate under different commands or instructions, the user either employs the keyboard 28, 38, 44 and the user interface on the web page to do so or requests that the controller initiate a messaging session where messages perform this function. Again, because the second communication is routed through the internet 24 and the IP-enabled controller 20, the overall cost of using the system 10 is reduced.

From the foregoing, those skilled in the art will recognize that the system 10 advantageously provides a method of substantially reducing the overall expense of using the system by reducing the cost associated with transmitting information related to the product 14 in the tank 16. The system 10, and in particular the IP-enabled controller 20, take advantage of the cost-effectiveness of the internet 24 to transmit information between the monitor 18, the controller 20, and the electronic device 22.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for monitoring parameters related to a product in a storage tank, comprising:
a monitor operably coupled to the storage tank;
an internet protocol (IP) enabled electronic device; and
an internet protocol enabled controller in communication with the monitor and the electronic device, the controller and the electronic device communicating through an internet regarding information observed by the monitor.

2. The system of claim 1, wherein the controller is configured to host a web page through which a user may view the information observed by the monitor.

3. The system of claim 1, wherein the controller includes a web server configured to host a web page, the web page including a user interface permitting a user to manipulate instructions governing operation of the monitor.

4. The system of claim 1, wherein the controller is equipped to initiate an instant messaging session with the electronic device.

5. The system of claim 1, wherein the controller is equipped to initiate an instant messaging session with the electronic device, the instant messaging session permitting a user to manipulate instructions governing operation of the monitor by at least one of sending and receiving instant messages.

6. The system of claim 1, wherein the system includes a network address translator (NAT) interposed between and in communication with the controller and the electronic device, the NAT operating without disrupting communication between the controller and the electronic device.

7. The system of claim 1, wherein the controller and the monitor communicate through a cellular communication network.

8. The system of claim 1, wherein the Internet-enabled electronic device is a device selected from the group consisting of a thin client, a data center, a server, a computer, a personal digital assistant (PDA), a wireless electronic mail device, a pager, and a cell phone.

9. The system of claim 1, wherein the controller and the electronic device communicate through the internet to relay instructions input into the electronic device regarding operation of the monitor.

10. The system of claim 1, wherein the controller includes an internal server and a memory, the internal server hosting a web page.

11. A system for monitoring parameters related to a product in a storage tank, comprising:
a monitor operably coupled to the storage tank;
an internet protocol (IP) enabled electronic device; and
an internet protocol enabled controller in communication with the monitor and the electronic device, the controller and the electronic device exchanging information regarding the product through an internet using an internet protocol.

12. The system of claim 11, wherein the internet protocol is from an internet protocol suite including transmission control protocol (TCP)/internet protocol (IP).

13. The system of claim 12, wherein the controller at least one of hosts a web page and initiates an instant messaging session.

14. The system of claim 13, wherein the monitor receives instructions from the electronic device, the instructions passing through the controller.

15. The system of claim 14, wherein the controller permits the instructions to pass through without manipulation.

16. A method of reducing transmission costs in a system employed to monitor a product in a storage tank, the method comprising the steps of:
transmitting measured parameters of the product through a first communication network; and
transmitting the measured parameters of the product through a second communication network using an internet protocol.

17. The method of claim 16, wherein the method further comprises the step of displaying the measured parameters.

18. The method of claim 17, wherein the method further comprises the step of transmitting instructions based on the measured parameters displayed.

19. The method of claim 16, wherein the method further comprises the step of hosting a web page.

20. The method of claim 19, wherein the method further comprises accessing the web page to view the measured parameters.
